(19) United States
(12) Patent Application Publication
(10) Pub. No.: US 2020/0033501 A1
(43) Pub. Date: Jan. 30, 2020

(54) IMPROVED METHODS RELATING TO QUALITY CONTROL

(71) Applicant: EQUINOR ENERGY AS, Stavanger (NO)

(72) Inventors: Erik NYRNES, Trondheim (NO); Jo SMISETH, Trondheim (NO); James ELGENES, Stavanger (NO)

(73) Assignee: EQUINOR ENERGY AS, Stavanger (NO)

(21) Appl. No.: 16/338,258

(22) PCT Filed: Sep. 25, 2017
(86) PCT No.: PCT/NO2017/050245

§ 371 Date: Mar. 29, 2019

(30) Foreign Application Priority Data
Sep. 30, 2016 (GB) 1616680.3

(51) Int. Cl. G01V 11/00; G01V 1/36; E21B 49/00; E21B 47/022

(52) U.S. Cl. CPC G01V 11/00; G01V 1/362; G01V 2210/6167; E21B 47/02216; G01V 2210/6163; E21B 49/003

(57) ABSTRACT

A method of performing quality control on a subsurface model of a subterranean region includes providing a plurality of types of data relating to subsurface characteristics in the subsurface model outside of one or more wellbores in the region, the plurality of types of data including wellbore data obtained from one or more measurement instruments located within at least one of the one or more wellbores, performing an analysis on the data to determine if there is an error or errors in the data; if an error is detected, searching for the cause of the error; if the cause of the error is detected, correcting the error; if the cause of the error is not detected, either ignoring the data containing the error or including in the model the data containing the error and allocating to the data containing the error an increased prior uncertainty thus reducing the influence on the model of the data containing the error.

### FIELD OF THE INVENTION

The invention relates to improved methods relating to quality control.

This may include quality control of interpreted structural information from in-well electromagnetic look around measurements or other in-well measurements in the volume surrounding the wellbore by combining these with interpreted seismic data in depth with uncertainties and with interpreted structural data from surrounding wells and the well itself.

### BACKGROUND OF THE INVENTION

UK Patent GB 2,467,687B describes a method of forming a geological model of a region of the Earth, which involves providing seismic data including seismic travel time uncertainty; providing a seismic velocity model of the region including velocity uncertainty; performing image ray tracing on the seismic data using the velocity model to determine the three dimensional positions of a plurality of points of the region; calculating three dimensional positional uncertainties of at least some of the points from the travel time uncertainty, the velocity uncertainty and uncertainty in ray propagation direction; and combining the determined positions with the calculated uncertainties to form a geological model.

UK Patent Application GB 2,486,877A describes a method of assessing the quality of subsurface position data and wellbore position data, comprising: providing a subsurface positional model of a region of the earth including the subsurface position data; providing a wellbore position model including the wellbore position data obtained from well-picks from wells in the region, each well-pick corresponding with a geological feature determined by a measurement taken in a well; identifying common points, each of which comprises a point in the subsurface positional model which corresponds to a well-pick of the wellbore position data; deriving an updated model of the region by adjusting at least one of the subsurface position data and the wellbore position data such that each common point has the most likely position in the subsurface positional model and the wellbore position data and has a local test value representing positional uncertainty; selecting some but not all of the common points and deriving a first test value from the local test values of the selected common points; providing a first positional error test limit for the selected common points; and comparing the first test value with the first test limit to provide a first assessment of data quality.

### SUMMARY OF THE INVENTION

The invention provides a method of performing quality control on a subsurface model of a subterranean region, a method of performing a survey, a method of extracting hydrocarbons from a subsurface region of the earth, a method of drilling a wellbore, a computer readable medium, and a programmed computer, as set out in the accompanying claims.

### BRIEF DESCRIPTION OF THE FIGURES

FIG. 1 describes an overall workflow of a method of calculating the likely positions of structures in a volume of the earth's crust;

FIG. 2 shows a Bottom Hole Assembly (BHA) with EM-sensors seen from the side;

FIG. 3 shows the same situation as shown in FIG. 2 but where the BHA is seen from above in a horizontal/lateral plane (from the vertical axis);

FIG. 4 shows an example where the EM sensors measure the vertical distance to a geological feature;

FIG. 5 shows the definition of well picks and formation structures;

FIG. 6 shows a Situation 1, and is a Seismic data section where we have drilled a well path shown by a solid white line;

FIG. 7 shows a Situation 2, and is a Seismic data section where we have drilled a well path shown by a solid white line;

FIG. 8 shows two uncertainty maps which represent the depth uncertainty for the top of the hydrocarbon reservoir;

FIG. 9 shows an example of a covariance matrix of two points, a well pick and a seismic point;

FIG. 10 shows an example of a covariance matrix of two statistically independent points;

FIG. 11 is a schematic drawing of a computer which may be used to carry out methods according to the invention;

FIG. 12 shows results before quality control;

FIG. 13 shows results after quality control; and

FIG. 14 shows a flowchart describing the generic steps of a proposed method.

### DESCRIPTION OF PREFERRED EMBODIMENTS

Preferred embodiments will now be described, by way of example only, with reference to the accompanying drawings.

Each feature disclosed or illustrated in the present specification may be incorporated in the invention, whether alone or in any appropriate combination with any other feature disclosed or illustrated herein.

We start by describing the accompanying drawings in the context of methods for structural modelling for calculating the likely positions of structures in the earth's crust. This assists background understanding. We then describe methods relating to quality control.

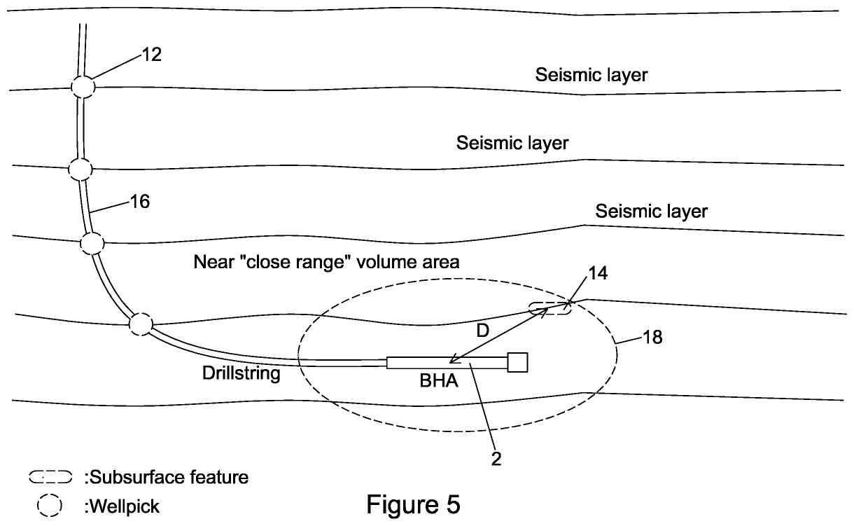

A starting point for the described embodiments is that the position of at least one point in the volume of the subsurface around the wellbore is measured by different types of instruments placed along the bottom hole assembly (BHA) in the wellbore. Examples of such measurements are deep azimuthal resistivity measurements, ahead of bit resistivity measurements, acoustic measurements, and neutron density measurements. These instruments can measure contrasts in for example electric resistivity which can correspond to for instance oil-water contacts and the top of hydrocarbon reservoirs. Moreover, the positions of formation structures in a subsurface area covering the wellbore are measured via seismic surveys. Formation structures penetrated by the wellbore are measured and interpreted, and may also have been measured for other wellbores in the subsurface area. These measurements are called “well picks”. FIG. 5 assists with the definition of well picks and formation structures.

Therefore at least three type of measurement may be used, namely in-well measurements around the wellbore, out-of-well seismic measurements, and well picks.

Well picks, subsurface features and near wellbore volume measurements are defined in FIG. 5. A subsurface feature can be for example a geological formation, structural surface, fault, fluid contact or any interfacing surface or line between two consecutive seismic layers. A well pick is identified by the log when the BHA is penetrating a layer. The absolute position of the borehole (measured by the Measurement While Drilling (MWD) directional survey instrument) is assigned to the well pick. A subsurface feature is identified within a limited volume around the BHA in the wellbore. The direction and distance from the BHA to the subsurface feature are calculated from the near volume measurements performed by the various sensors in the BHA.

An acoustic velocity model is a model that quantifies the speed of sound for all the positions in the subsurface. The basic concept of velocity model building is to use the travel time of for instance time migrated acoustic waves to image the subsurface.

Assume that we have an acoustic velocity model available for the formation structures in the subsurface area. The velocities can be obtained using the relationship between time and depth (V=D/T) with the depth (D) as the geological well observations and the time (T) as the seismic interpretation. Assume that we have a seismic depth model available. A depth model is a collection of the coordinates and corresponding uncertainties of the subsurface structures. The depth model can be obtained by combining the velocity model with seismic data interpreted in the time domain. Assume that we also have available the measurements in the volume around the wellbore along with uncertainties of these measurements, and the well picks with uncertainties in three spatial dimensions. The uncertainties (statistical properties) of every spatial point in the depth model are represented by the covariance matrix. The covariance matrix consists of variances on the diagonal elements, and covariances on the off-diagonal elements. Covariances describe the statistical dependencies between coordinates. Similarly, the statistical dependencies between coordinates of spatial points (being a seismic point, a well pick, or a point measured in the volume around the wellbore) are expressed in terms of covariances of a joint covariance matrix. FIG. 9 shows an example of such a joint covariance matrix for two spatial points in 3D, in this case a well pick and a seismic point.

We first make some comments relating to the directional surveys of the wellbore. The basic measurements are the length along the wellbore from a reference point at the surface, and the two directional components called inclination and azimuth. The inclination is defined as the deflection of the wellbore axis with respect to the gravity field vector, while the azimuth is the direction in the horizon plane with respect to north. A common method for measuring the direction of the wellbore is to use a magnetic MWD survey instrument. Such an instrument consists of accelerometers and magnetometers which measure components of the Earth's gravity field and the Earth's magnetic field, respectively. The accelerometer measurements are used to determine the inclination of the wellbore, whereas the azimuth is determined from the magnetometer measurements. The position of the wellbore is a function of inclination, azimuth and the length of the drillstring from a surface reference point.

It is possible to update the depth model and the corresponding full covariance matrix with interpreted structural information from 3D directional and distance measurements (and corresponding statistical properties) in the near volume around the wellbore, e.g. by the use resistivity measurements. A measurement of a point in the near volume around the wellbore with sensors in the BHA is illustrated in FIG. 5. The uncertainties of near volume measurements can be stipulated prior to drilling based on sensor specific error models, or estimated as a by-product of the least squares estimation approach.

It is possible to start by identifying one or more points of measurement in the near volume around the wellbore which correspond to structural formations in the depth model. The points can for example be interpreted from an image reflecting the electric resistivity of the volume surrounding the probing device. These points may be assigned with up to three dimensional spatial coordinates. The coordinates of such a point are estimated by using the survey of the wellbore as a reference combined with the resistivity model to find the relative distance and direction from a well reference point (determined from the above-mentioned survey of the wellbore) to the interpreted point (corresponding with a structural formation). Each such point in the structural formation must also be assigned with statistical properties, reflected in a point covariance matrix. This prior covariance matrix may be obtained by applying the law of covariance propagation on the three available types of positional information; the survey of the wellbore, the resistivity model, and the interpretation of the structural formation from the resistivity model. The measurements in the volume around the wellbore could be a collection of points which resembles a line or surface. In such a collection of points each point would potentially be correlated with all the other points. The correlation between points can be modeled by a joint covariance matrix for all consecutive measurement points in the near wellbore volume. This joint prior covariance matrix may be obtained by applying the law of covariance propagation on the three available types of positional information as described above.

All the available positional information (such as coordinates of well picks, coordinates of seismic points, coordinates of wellbore reference points and near wellbore volume measurements) may be mutually statistically dependent. Such types of correlations can be expressed by covariance components in a joint co-variance matrix. This joint prior covariance matrix may be obtained by applying the law of covariance propagation on available types of positional information.

The measured points in the near volume around the wellbore and well picks can be tied to the seismic depth model through constraining equations. A constraining equation expresses mathematically that the coordinates of a point measured from the wellbore (being either a well-pick or a near volume measurement) are equal to or differ with a certain defined distance from the corresponding point in the seismic depth model. The most probable positions of all the points in the depth model with corresponding statistical properties (which may be expressed by a covariance matrix) are calculated based on this redundant measurement information (using for instance a least squares estimation approach such as the one described in the patent EP1306694 by Torgeir Torkildsen). A least squares estimation approach may be applied for this purpose. In such a way the prior positional information is adjusted correctly based on its prior positional statistical properties.

The procedure of tying points measured from the wellbore with the seismic depth model may be summarized by the following steps:
1. Gather initial positional information including covariance matrices
2. Define constraining equations to tie together positional information
3. Adjust the positional information and the joint covariance matrix based on introducing constraining equations and the method of least squares

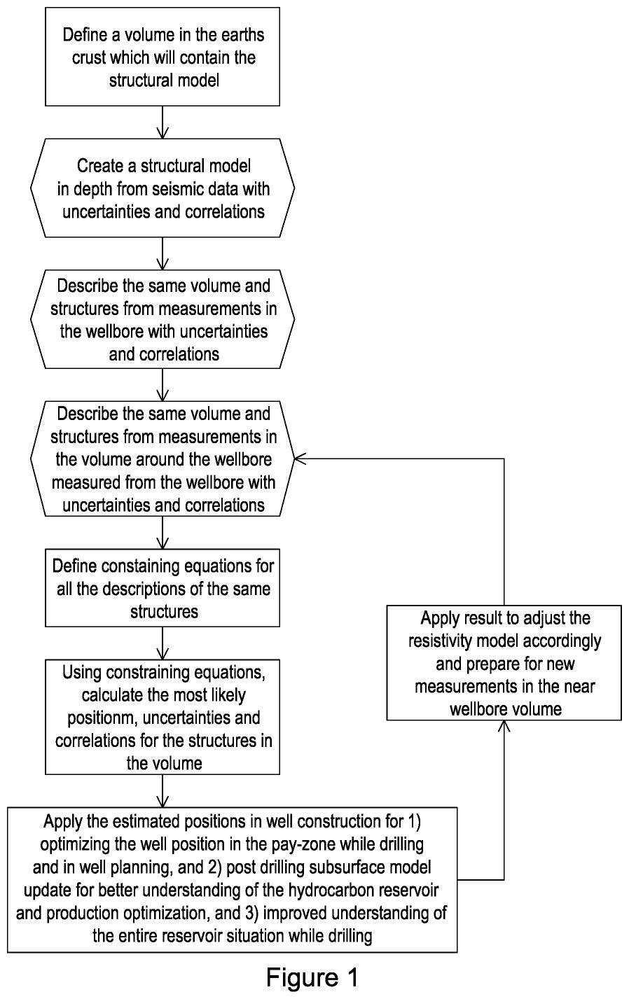

The result is a depth model with statistical properties which are correctly adjusted based on all available positional information with corresponding statistical properties. This result may be applied to adjust the resistivity model accordingly and prepare for new measurements in the near wellbore volume. The overall workflow describing the a preferred embodiment is shown in FIG. 1. The element of including measurements with corresponding uncertainties and correlations from the volume surrounding the wellbore measured from the wellbore with deep azimuthal resistivity measurements as an example are described in the figures below.

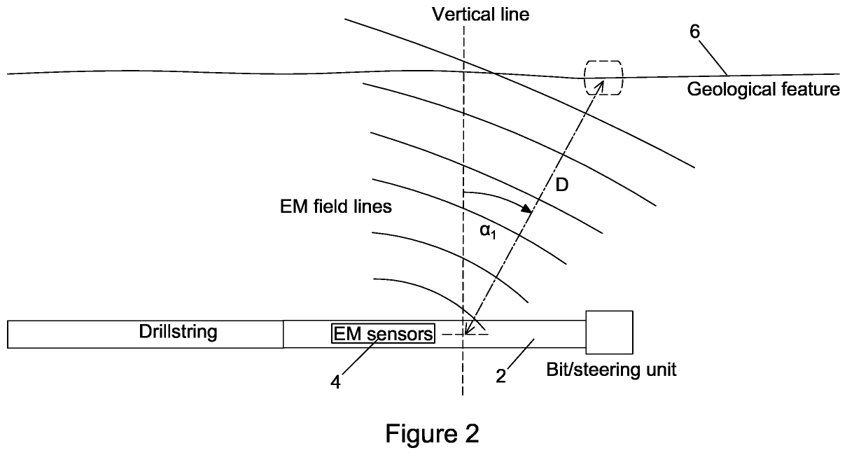

FIG. 2 shows a Bottom Hole Assembly (BHA) 2 with EM-sensors 4 seen from the side. When the distance is measured from several discrete positions (survey points) along the wellpath the position of the geological feature 6 can be calculated using e.g. trilateration techniques. When directional measurements are available in addition to distances, 3D triangulation adjustment techniques can be applied. The figure shows an example where the EM sensor package 4 measures the 3D distance and 3D direction to a certain geological feature 6 (horizon surface etc.). From these measurements the 3D position of the geological feature 6 is determined. The 3D position of the geological feature 6 can be calculated with respect to a local BHA-based coordinate system, or represented by North, East and True Vertical Depth (TVD) coordinates.

Based on accelerometer and magnetometer sensors in the Measurement While Drilling (MWD) survey package it is possible to determine the orientation of the BHA (including the EM sensor package) with respect to a global North, East and TVD coordinate system. It will then be possible to transform between coordinates in the local BHA-based coordinate system and the global North, East and TVD coordinate system.

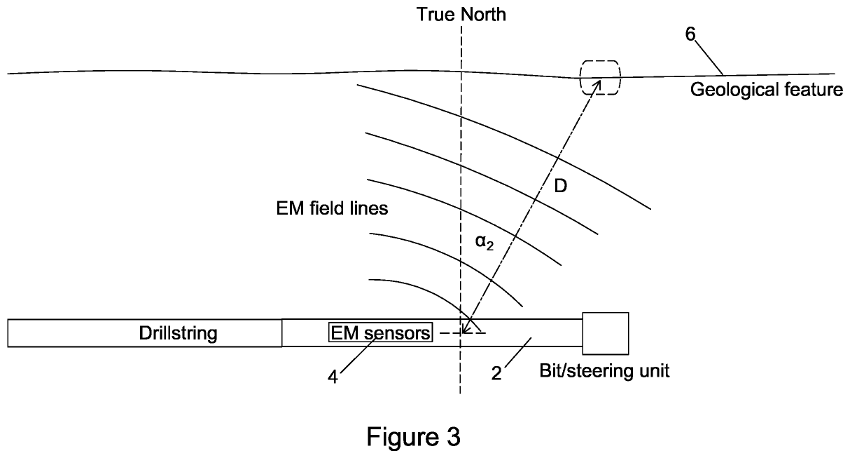

FIG. 3 shows the same situation as shown in FIG. 2 but where the BHA 2 is seen in a horizontal/lateral plane (from the vertical axis).

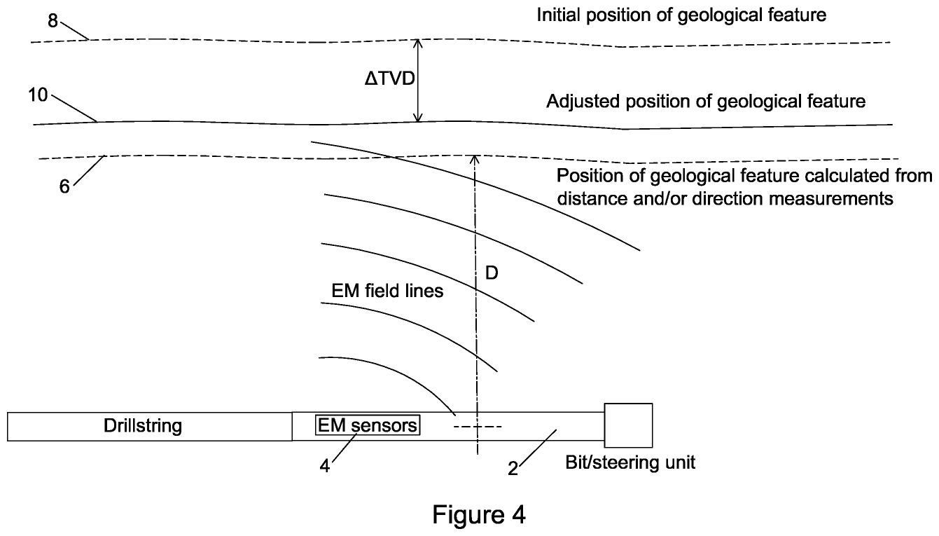

FIG. 4 shows an example where the EM sensors 4 measure the vertical distance to a geological feature 6. The same geological feature (shown by the dashed line 8) is also determined based on seismic data only. This surface has high uncertainty due to the relatively poor seismic accuracy. The measured distance (D) ties together the vertical position of the BHA 2 and the vertical position of the geological feature 6. The accuracy of the measured distance defines the stringency of this constraint. Because the position of the BHA 2 has significantly better accuracy than the initial position of the geological feature 8 (determined by using the prior time and velocity input to the model), the adjusted vertical position of the surface (solid line 10) will end up closer to the initial vertical position of the geological feature 6 that was originally measured by the EM tool 4. The result is an adjusted geological surface with improved TVD accuracy.

Applications of the methods described will now be described.

The updated structural model can be applied to optimize the position of the drill bit in the pay-zone (i.e. the region producing hydrocarbons) in a while-drilling situation. Moreover, the updated model may be applied in the well planning phase for new wells in the region to provide more optimal well path placements for these. Finally, the updated model may be applied post drilling for creating a better understanding of the reservoir situation around the well, to optimize production in the production phase.

FIG. 5 shows the definition of well picks 12, subsurface features 14 and near wellbore volume measurements. A well pick 12 is identified by the log when the BHA 2 is penetrating a layer. The absolute position of the borehole 16 (measured by the MWD directional survey instrument) is assigned to the well pick 12. A subsurface feature 14 is identified within a limited volume 18 around the BHA 2 in the wellbore 16. The direction and distance from the BHA 2 to the subsurface feature 14 are calculated from the near volume measurements performed by the various sensors in the BHA 2, for instance one or more resistivity sensors distributed along the BHA 2.

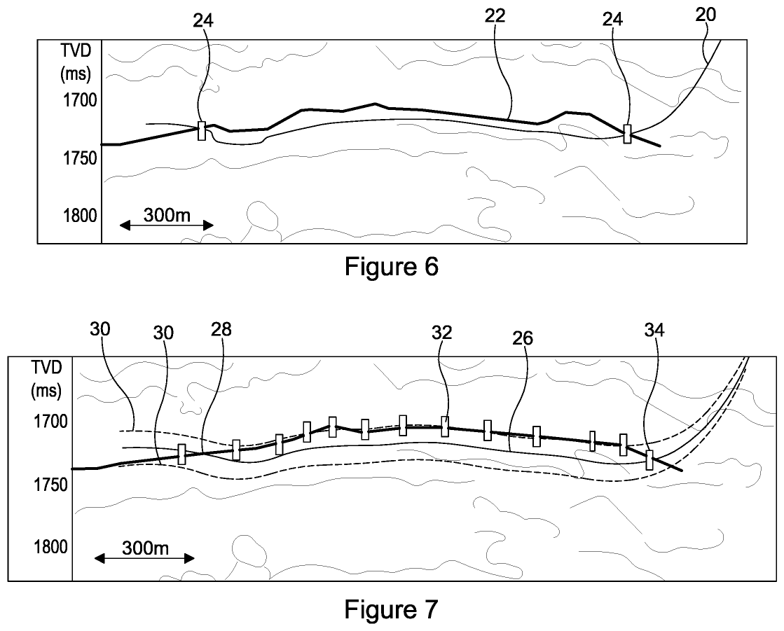

FIG. 6 shows a Situation 1, and is a Seismic data section where we have drilled a well path 20 shown by a solid white line. The black line is a seismic horizon 22 which represents the seismic interpretation of the top of a hydrocarbon reservoir. We have not utilized any electric resistivity measurements in this situation but we have calibrated the seismic horizon to the drilled well picks, represented by the black markers 24. In this example, we have a lot of uncertainty regarding the geometry and topography of the top of the hydrocarbon reservoir (black line) between the well pick markers 24. The depth of the top of the reservoir is uncertain and we risk missing out on potential volumes if we need to sidetrack (drill to the side of the well path) or drill another well in the area.

FIG. 7: shows a Situation 2, and is a Seismic section where we have drilled a well path 26 shown by a white line and a seismic interpretation 28 shown by a black line. The white dotted lines 30 represent the theoretical depth range of penetration for EM deep resistivity measurements (+−10 m). The white markers 32 represent the detection of the top reservoir from the deep resistivity measurements. The black markers 34 represent the drilled well picks. We have calibrated the seismic horizon 28 to the white markers 32 and the black markers 34. The markers, interpretation and the well survey all have an associated uncertainty which are algebraically combined to give an up to date overall position and uncertainty of the top reservoir surface. In this example, we have an updated top reservoir depth surface which can be used to optimize the position of a well plan in a drilling situation and can also be used post drilling in order to constrain volumes and optimize production.

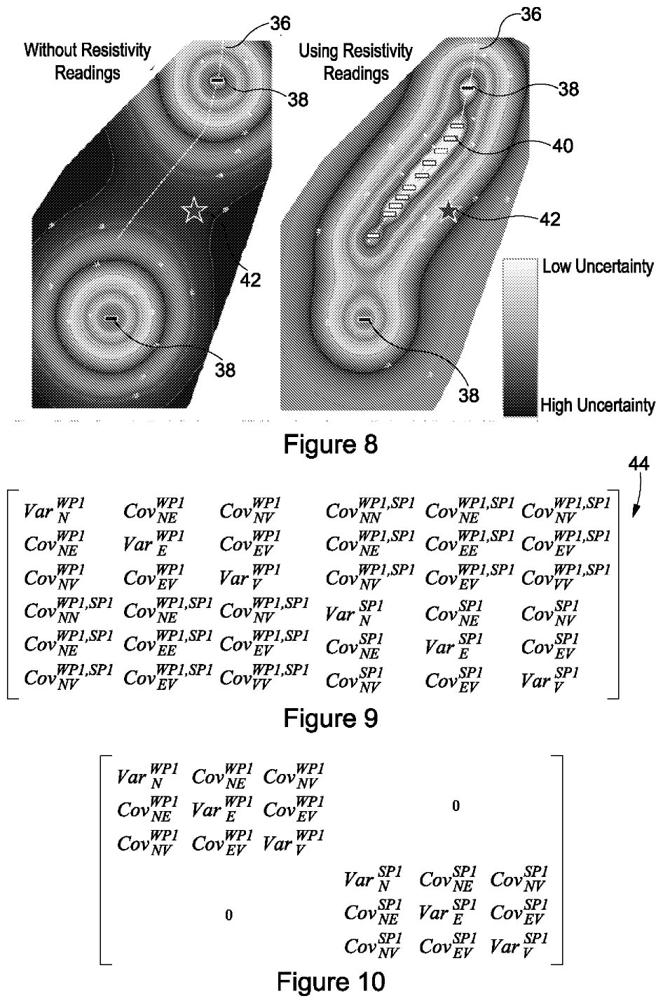

FIG. 8 shows two uncertainty maps which represent the depth uncertainty for the top of the hydrocarbon reservoir. A drilled well is represented by a white dotted line 36. The black markers 38 represent geological well observations for the top of the hydrocarbon reservoir and the white markers 40 represent deep resistivity well observations for the top of the hydrocarbon reservoir. The figure to the left can be directly comparable to the situation shown in FIG. 6 which has not used the deep resistivity readings. Imagine we have to drill a new well at a reservoir target represented by the black star 42. Without using any deep resistivity observations, we would have an uncertainty of +−20 m at 2 standard deviations.

The figure to the right is now integrating both the drilled geological well observations and the deep resistivity well observations. This corresponds to the situation shown in FIG. 7. Now we have an optimized surface which will reduce the uncertainties to 12 m at 2 standard deviations at the black star target location 42.

FIG. 9 shows an example of a joint covariance matrix 44 of two points in 3D, a well pick (represented by WP1 in the matrix) and a seismic point (represented by SP1 in the matrix). The statistical dependencies between the coordinates of the well pick and the coordinates of the seismic point are described by the 3 times 3 matrices in the upper right and lower left corners, respectively. The 3 times 3 matrices in the upper left and lower right corner are the covariance matrices of the well pick and seismic point respectively. The diagonal elements of the joint covariance matrix are the variances of the coordinates of the well pick and seismic point.

FIG. 10 shows an example where the well pick and seismic point are statistically independent. This is expressed through zero covariances between the coordinates of the well pick and the coordinates of the seismic point.

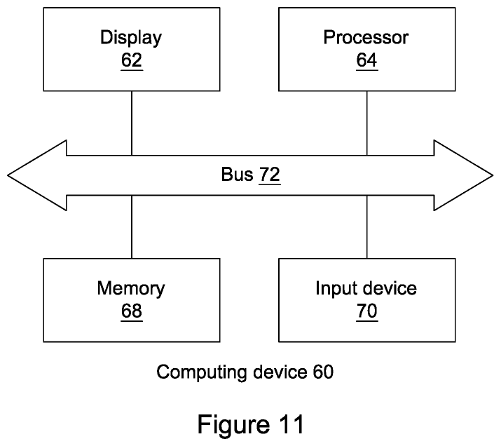

FIG. 11 shows a computer suitable for carrying out methods described herein. FIG. 11 shows a computing device 60, which may for example be a personal computer (PC), on which methods described herein can be carried out. The computing device 60 comprises a display 62 for displaying information, a processor 64, a memory 68 and an input device 70 for allowing information to be input to the computing device. The input device 70 may for example include a connection to other computers or to computer readable media, and may also include a mouse or keyboard for allowing a user to enter information. These elements are connected by a bus 72 via which information is exchanged between the components.

We now describe features relating to quality control.

As noted above, a starting point for embodiments described here is that the position of at least one point in the volume of the subsurface around the wellbore is measured by different types of instruments placed along the bottom hole assembly (BHA) in the wellbore.

Suppose that positional information (up to 3D) of seismic subsurface formation structures is available. This information may include interpretations of seismic reflectors as geological formation structures, an acoustic velocity field (up to 3 dimensions), and uncertainty models for the positions of the seismic reflectors and for the velocity field. An acoustic velocity model describes an estimated velocity of a subsurface medium which can be used to convert acoustic travel time to depth. The uncertainty models describe the positional uncertainties of the interpreted seismic reflectors, the uncertainty of the velocity fields, and the correlations between these. A covariance matrix is created by using the mathematical law of variance-covariance propagation through the linearized Gaussian uncertainty model scheme; i.e. the set of equations defining the propagation of sound waves are linearized through a Taylor series expansion from which the variances and covariances of the positions are estimated. This information (positions and corresponding covariance matrices) will herein be referred to as seismic interpretation data.

Suppose that it is possible to identify or interpret the positions of one or more of the subsurface structures described by the seismic interpretation data based on measurements (for example electric resistivity measurements) in the close range volume around the wellbore as described in FIG. 4. 3D positional uncertainties of these positions can be estimated in a similar way as for the seismic interpretation data as described above. This type of positional information will hereafter be called close range wellbore information. The methods for estimating the positions are described in FIG. 1-FIG. 3. The uncertainties are a combination of the uncertainty (e.g. noise) in the actual measurement and the uncertainty of the interpretation of the subsurface structures.

Subsurface positional information includes covariances, for example covariances between survey stations (at which drilling may be stopped every approx. 30 m to collect measurements) and geological formations. The correlations between position coordinates, which are measures of linear statistical dependency, are closely related to covariances. The covariance matrices are not restricted to 3*3 covariance matrices of NEV (North, East, Vertical) coordinates of individual points, but can also involve a complete covariance matrix which contains the correlations between NEV coordinates of each point of the entire subsurface model.

Assume that we have computer software and methodology available for combining three different types of information:

1) seismic interpretation data

2) close range wellbore information, and

3) well picks with corresponding uncertainties.

The software can estimate the most likely positions of subsurface formation structures with a corresponding full covariance matrix in 3D. This model will be called an updated subsurface model.

The methods described in the following will utilize the combined positional data for quality control of each type of measurements defined in points 1)-3) in the paragraph above.

Any of the methods described herein may also include the step of acquiring said three different types of data which may then be processed in accordance with the methods described.

A novel aspect of embodiments described here is to perform quality control of different types of subsurface positional information, such as; 1) coordinates and prior uncertainties of points which have been derived from seismic, 2) coordinates of points interpreted from measurements in the close range volume around the wellbore and the prior uncertainties of these coordinates, and 3) coordinates of well-picks derived from wellbore directional surveys and well logs, and a priori uncertainty of these coordinates and well logs. The collection of such points and the corresponding covariance matrix is called a subsurface model. This invention is to utilize multiple measurements of the same geological feature, i.e. redundant measurements, for quality control purposes. In this context, quality control is defined as procedures for detection of gross errors in any type of measurements in the groups 1), 2) and 3) above in addition to input parameters such as covariance matrices, depth reference systems, and human errors (such as interpretation errors, typing errors etc.).

The quality control (QC) approach will include two levels.
Level 1: Quality control of the various sensor measurements which are used to calculate the coordinates mentioned under point 2) above. These are redundant measurements of the same feature within the close range volume. Examples of such measurements are explanations of how they are utilized are given by FIG. 1 and FIG. 2.
Level 2: Quality control applied directly to the coordinates of the structural feature which are derived from the redundant measurements.

In the following the term “observation” will be used as a common expression for all types of measurements, like sensor readings and point coordinates of well picks and subsurface features.

Several data quality control test methods will be defined:

Test 1: General Data Consistency Test

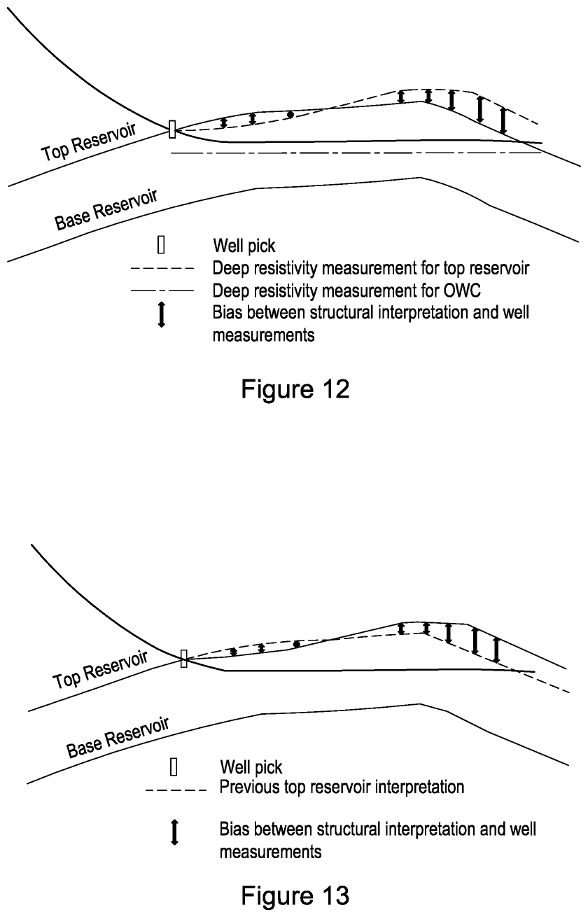

The (known) general data consistency test is useful to evaluate the overall quality of positional information of both levels of QC (Level 1 sensor measurements and Level 2 coordinates) defined above when these are included in a subsurface model, either before drilling operations, whilst, or after drilling operations. This test is based on the residual sum of squares and the resulting estimated variance factor \hat{σ}²:

$${\hat{σ}}^{2} = \frac{{\hat{e}}^{T} {Q}_{ee}^{- 1} \hat{e}}{n - u} ,$$

where ê is a vector of so-called residuals that reflect the agreement between initial and adjusted positions (where adjustments may be made by least squares estimation), Qₑₑ is the covariance matrix of measurement errors, and n-u is the degrees of freedom. (n is the number of measurements, u is the number of unknown coordinates, and T indicates “transposed”.) The general data consistency test evaluates whether the actual variance factor \hat{σ}² is significantly different from its prior assumed value σ₀². An example is illustrated in FIG. 12.

The hypotheses for the general data consistency test can be expressed as follows:

H₀: σ²=σ₀² and H_{A}: σ²≠σ₀²,

H₀ is rejected at the given likelihood level α if:

$${\hat{σ}}^{2} > {K}_{1 - \frac{α}{2}} or {\hat{σ}}^{2} < {K}_{\frac{α}{2}} ,$$

where

$${K}_{1 - \frac{α}{2}}$$

denotes an upper (1-α/2) percentage point of a suitable statistical distribution at a specific number of degrees of freedom The test value can be found in statistical look-up tables. The distribution of the test-value has to be equal to the distribution of the test-limit. The likelihood parameter α is often called the significance level of the test, which is the likelihood of concluding that the observation data contain gross errors when in fact this is not the case. The likelihood level is therefore the probability of making the wrong conclusion, i.e. concluding that gross errors are present when they are not.

The estimated variance factor can be used as a basis for estimation of the actual noise of a particular group of sensor readings.

Test 2: Single Measurement Gross Error Test

The (known) single measurement gross error test procedure can be defined as follows:

Use a statistical testing procedure to evaluate whether a single sensor reading, a well-pick, or a geological feature point within the close range volume, is affected by a gross error. The test evaluates whether the gross error estimate is significantly different from a certain prior assumption, for instance zero.

The test for a gross error in the i^{th} point or sensor measurement may be expressed by the two hypotheses:

H₀: ∇ᵢ=0 and H_{A}: ∇ᵢ≠0

where ∇ᵢ denotes the gross error that corresponds to the ith measurement or ith point. The gross error estimate in for instance the vertical direction can be estimated analytically using e.g. the method of least squares.

The test value for testing the two hypotheses H₀ and H_{A} is given by:

$$t = \vert \frac{{\hat{∇}}_{i}}{{σ}_{{\hat{∇}}_{i}}} \vert$$

where σ_{\hat{∇}} is the standard deviation of the estimator \hat{∇}ᵢ of the gross error.

The null hypothesis H₀ is rejected when the test value t is greater than a specified test-limit t_{α/2}. The test-limit t_{α/2} is the limit of which a given well-pick is classified as a gross error or not, and is the upper α/2 quantile of a suitable statistical distribution. If H₀ is rejected this implies that the error is significantly different from zero and the conclusion is that the actual measurement or a point coordinate is affected by a gross error.

This test may be carried out in a successive manner, varying the index i from 1 to the total number of observations to be tested. Observations are in this context defined as single sensor readings, well picks, geological feature points, etc.

Test 3: Systematic Gross Error Test

By this test the quality of certain groups of measurements is verified simultaneously. Measurements can in this context be a group of well-picks or geological feature points within the close range volume, or they can be a group of close range volume measurements performed by the same or different types of sensors. The purpose with this test is to detect systematic errors affecting for instance a number of measurements performed by a certain sensor type. The test is especially relevant to detect systematic errors, for instance when several points or several sensor measurements are affected by the same error source(s).

This test procedure is performed in a similar successive manner as Test 2 described above, except that the bias parameter ∇ describes systematic errors instead of a single gross error. Thus, the main difference is that this test can detect gross errors which are common for several points or sensor measurements. This test may also be carried out in a successive manner, similarly to Test 2.

Test 4: Test For Systematic Errors and Gross Errors Simultaneously

This test can be considered as a combination of Test 2 and Test 3. The purpose of this test is to simultaneously detect systematic errors and/or individual gross errors in one or more groups of observations, by deriving one single test value only.

The starting point of this test procedure is that the user identifies a set of observations to be tested; gross errors in individual observations and gross systematic errors in groups of observations. These could be sensor measurements and points which are not proven to be gross errors by Test 2 and 3, but which the user suspects are affected by gross errors. The test concludes whether the selected observations will cause significant improvements to the overall quality of the observation data if they are excluded from the dataset.

By applying this test procedure, the user is able to estimate the magnitude of all these errors simultaneously, and perform a statistical test to decide whether all these well-picks simultaneously can be considered as gross errors.

The test can be summarized by the following steps:

a) Select which observations are to be tested.

b) Sort out which observations are believed to represent gross errors, and groups of observations that are believed to represent systematic errors.

c) Estimate the errors in the selected observations

d) Calculate the common test-value. This test-value is a function of the errors estimated in the previous step (step c.).

e) Check if the common test-value is greater than the test limit. If so, the selected observations constitute a gross model error that should be excluded from the dataset, otherwise not.

In step c) above the errors can be estimated using the method of least squares.

Workflow

Workflow steps prior to drilling application:
1. Starting point: entire subsurface model without the close range wellbore information data (information type 2 defined above)
2. Include all available close range wellbore information (from all wells)
3. Perform a general data consistency test (Test 1)
4. Outcome of general data consistency test results and possible actions:
   The test does not indicate any presence of gross errors: This indicates overall consistency in the dataset (no extreme gross errors such as typing errors, sign errors, reference errors, interpretation errors, wrong assumptions about the stochastic model (such as wrong correlation assumptions) etc.). Continue to the next step to test specific observations.
   The test does indicate presence of gross errors: Continue to the next step to test specific observations so that the correct diagnostics can be performed (detect extreme gross error such as typing errors, sign errors, reference errors, interpretation errors, wrong assumptions about the stochastic model, and/or gross errors in individual measurements etc.).
5. According to whether sensor specific measurements or pre-calculated coordinates are available, perform QC using Test 2, 3, and 4. The most optimal is to perform QC according to Level 1 as this makes it easier to pin-point the actual cause of the gross error, whether it is due to an error in e.g. EM-measurements, acoustic measurements, the tool reference point, etc. However, if a measurement is deemed to be a gross error, the error may not necessarily be related to corrupted close range wellbore information but can also be a result of an undetected gross error in the seismic or well pick information.
6. Possible outcome of QC results and suggested actions:
   No gross errors detected in any data: This indicates an agreement between the prior model assumptions and the actual model data quality.
   Gross error in single observation: Evaluate the situation and the reliability of all relevant input data. If the cause of the gross error is detected, correct the input data if possible and repeat the QC to ensure information consistency. If the cause of the gross error is not detected, ignore the measurement or include the measurement with a modified prior uncertainty.
   Gross error in several consecutive observations, both systematic and non-systematic: If systematic, evaluate if there are underlying reasons for why a number of consecutive measurements are systematically biased. If non-systematic (random noise), this could be caused by e.g. sensor imperfections. If the cause of the gross error is identified, correct the input data if possible and repeat the QC to ensure information consistency. If the cause of the gross error is not detected, ignore the observations or include them with modified prior uncertainties.
   Gross errors in a number of single and/or several, not necessarily consecutive, observations detected and classified as a group representing a gross model mis-specification. If the cause of the model mis-specification is identified, correct data if possible and repeat the QC to ensure consistency. Otherwise exclude the observations or assign them different prior uncertainties.
7. Return to step 3 in the workflow, and repeat until overall data consistency is acceptable and no gross errors are detected.

Workflow steps for while drilling and post drilling applications:
1. Starting point: entire subsurface model including any available close range wellbore observations.
2. Collect close range wellbore information at a given measured depth. The observations can come from one or more different sensor types. Observations can be collected on at least two different formats; either as raw sensor measurements or as point coordinates derived based on the raw sensor measurements.
3. Depending on whether sensor specific measurements or pre-calculated coordinates are available, perform QC according to Test 2 (or Test 3 if a sufficient number of observations have been collected) on either Level 1 data (ie sensor measurements) or Level 2 data (ie coordinates of features) defined above.
4. Outcome of QC results and possible actions:
   Single observation not declared as a gross error: Continue drilling and collect more observations.
   Single observation declared as a gross error: Evaluate the situation and the reliability of all relevant input data. Consider repeating the measurements and repeat QC procedure. If the cause of the gross error is detected correct the input data if possible and repeat the QC to ensure information consistency. If the cause of the gross error is not detected, ignore the measurement or include the measurement with a modified prior uncertainty.
   A multiple of observations declared as a gross systematic error: Evaluate the situation and the reliability of all relevant input data. Consider using the estimated size of the systematic error to correct all affected measurements. The accuracy performance of such a real time calibration is dependent on the number of available observations. Repeat the QC to ensure information consistency. If the cause of the systematic gross error is not detected, ignore the measurement or include the measurement with a modified prior uncertainty.
5. Continue drilling and collect more measurements
6. When section is drilled to TD (target depth), perform QC (quality control) according to Test 1 to ensure data consistency. If we through Test 2 and 3 have indications of undetected gross errors, apply Test 4 to evaluate whether the measurements involved together constitute a significant model mis-specification.

Alternative QC Approach—Increasing Prior Uncertainties

Instead of applying a statistical significance test to each observation in the data set and remove measurements which are declared as gross errors, another approach is to keep these observations in the data set and increase their prior uncertainties to reduce their influence on the final estimation result. The new value of the prior uncertainty (variance) can for instance be calculated as a function of the observation residual. An example is to assign a large variance to a measurement which has a large residual. The effect of this will be that this measurement, which is most likely noisier, will have reduced influence on the estimation result. This is reasonable as a gross error in an observation will most often be reflected in the size of the residual of that observation. This down-weighting principle will be applied to every observation in the data set. The final result is a modified covariance matrix of the observations, which reduces the influence of observations with gross errors.

FIG. 12 shows results before quality control. The reservoir is being drilled and deep resistivity data are being used to detect the top of the reservoir. Whilst drilling, the QC steps involved detect that there are discrepancies (bias) between the interpreted structural information (seismic horizon) and the deep resistivity data.

FIG. 13 shows results after quality control, when it was decided that the previous structural interpretation of the top reservoir surface was incorrect. The interpretation was updated and adjusted to the deep resistivity data in order to give an up to date top reservoir surface. If a new well/sidetrack is needed to be drilled then a quality controlled and up to date top reservoir surface will decrease the risk of unexpected sidetracks and increase the chances of a better well placement.

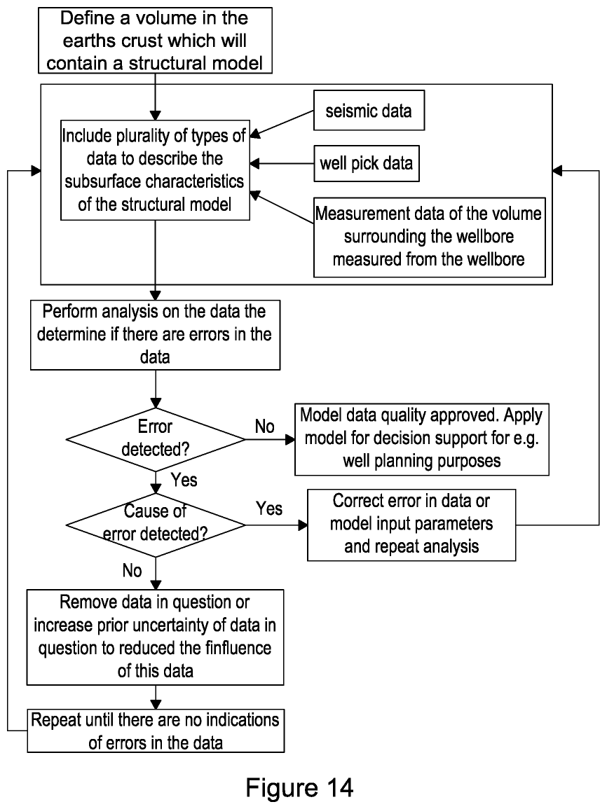

FIG. 14 shows a flowchart describing the following generic steps of a proposed method. Starting with defining a volume in the earth's crust which contains the model, several types of data are included in the model. These could be seismic data and well pick data, and include wellbore data obtained from one or more measurement instruments located in a wellbore. Data include measurements and interpretations with corresponding uncertainties, as well as correlations between data points. Model parameters describing, for example, resolution can also be provided in this phase. An analysis is then performed in order to determine if there are systematic errors or gross errors in the data. If no errors are detected, the model can be applied in decision support in e.g. well planning and drilling operations. If an error is detected and the cause of the error is identified, the relevant data or model input parameter(s) is/are corrected, and the analysis is repeated. If the cause of the error is not detected, the relevant data can be ignored, or the corresponding prior uncertainty can be increased to reduce the influence of the data. The analysis is then repeated until no errors are detected.

We have described methods relating to QC of data outside a wellbore. The methods can also be applied for QC of well pick data (inside the wellbore) and seismic data.

The subsurface model may include well picks and seismic data. We can evaluate all this data together.

Various advantages arise when the methods described here are used for data quality control in the processes mentioned above. Improved data quality improves the decision basis for decisions about well placement which can improve sweet spot prediction and give more optimal positioning in the pay zone. An automatic and systematic approach as proposed here will significantly improve current manual procedures because the amounts of data and correlations between data are larger than single humans can handle. The methods provide advantages while drilling (QC new and existing wells, seismic), after drilling (QC important for production optimization), and in planning processes (qc existing wells, seismic).

Other possible application areas:
Recursive updating of the model to save computation time. Estimate the position without performing a full matrix inversion
Calibration of sensors: Systematic errors in the sensors, such as resistivity sensors, can be estimated as part of the least squares trilateration/triangulation.
Estimation of sensor noise is possible through the least squares estimation approach (residual noise).
Detection of systematic errors in seismic interpretation
Can determine the distance and direction to the feature based on multiple measurements (i.e. more than one distance and direction measurement) from a multiple of sensors or from multiple frequencies from the same sensor in the BHA.
QC can be applied to check that valid data are used when giving advice during geo-steering operations, and check that the uncertainty levels are correct.

It should be appreciated that any of the methods described herein may also include the step of acquiring data, including seismic and/or electromagnetic data, which may then be processed in accordance with the method.

Relevant software for this application are
Software for processing of resistivity data and presenting resistivity images for interpretation. Examples are AziTrak™ deep azimuthal resistivity measurement tool from Baker Hughes which allows for geo-steering and software for electromagnetic look-ahead EMLA developed by Schlumberger and Statoil
Geo-modelling software such as Landmark DecisionSpace Desktop and Petrel from Schlumberger
Seismic depth conversion tools such as Paradigm Explorer, COHIBA from Roxar, and EasyDC.
Landmark Compass software tool for well path positional uncertainty estimation
PinPoint (Statoil internal)

The invention includes a method of performing quality control on a subsurface model of a subterranean region, said method comprising:

providing a plurality of types of data relating to subsurface characteristics in said subsurface model outside of one or more wellbores in said region, said plurality of types of data including wellbore data obtained from one or more measurement instruments located within at least one of said one or more wellbores,

performing an analysis on said data to determine if there is an error or errors in said data;

if an error is detected, searching for the cause of said error;

if the cause of said error is detected, correcting said error;

if the cause of said error is not detected, either ignoring the data containing said error or including in said model the data containing said error and allocating to the data containing said error an increased prior uncertainty thus reducing the influence on said model of the data containing said error.

This method may be combined with the features of any of the accompanying claims.

1. A method of performing quality control on a subsurface model of a subterranean region, said method comprising:
providing a plurality of types of data relating to subsurface characteristics in said subsurface model outside of one or more wellbores in said region, said plurality of types of data including wellbore data obtained from one or more measurement instruments located within at least one of said one or more wellbores,
performing an analysis on said data to determine if there is an error or errors in said data;
if an error is detected, searching for the cause of said error;
if the cause of said error is detected, correcting said error;
if the cause of said error is not detected, including in said model the data containing said error and allocating to the data containing said error an increased prior uncertainty thus reducing the influence on said model of the data containing said error.

2. The method as claimed in claim 1, wherein said analysis includes performing a plurality of statistical tests on said data.

3. The method as claimed in claim 1, wherein said plurality of types of data include seismic data.

4. The method as claimed in claim 1, wherein said wellbore data includes any or all of the following types of data: resistivity measurements; acoustic measurements; and neutron density measurements.

5. The method as claimed in claim 1, wherein said plurality of types of data include well pick data.

6. The method as claimed in claim 5, wherein said well pick data is produced from any or all of the following:
a) the measured direction of said at least one wellbore at at least one point along the wellbore;
b) the distance of the well pick from the top of said at least one wellbore, as measured along the length of the wellbore; and
c) interpretations of formation structures from well logs of said at least one wellbore.

7. The method as claimed in claim 1, wherein said plurality of types of data include sensor measurements which are used to calculate coordinates of points in said subsurface model.

8. The method as claimed in claim 1, wherein said plurality of types of data include coordinates of points in said subsurface model.

9. The method as claimed in claim 1, which includes performing a general data consistency test to determine the likelihood that said data contain gross errors.

10. The method as claimed in claim 9, wherein said general data consistency test is a statistical test.

11. The method as claimed in claim 1, which includes performing a single measurement gross error test to determine whether a single item of said data is affected by a gross error.

12. The method as claimed in claim 11, wherein said single measurement gross error test is a statistical hypothesis test.

13. The method as claimed in claim 11, wherein said single item of said data is a single sensor reading, a well pick or a geological feature point in said model.

14. The method as claimed in claim 11, further comprising the following steps if a gross error is detected:
if the cause of said gross error is detected, correcting said single item of said data; and
if the cause of said gross error is not detected, either ignoring said single item of said data or including said single item of said data in said subsurface model with a modified prior uncertainty.

15. The method as claimed in claim 11, which further comprises:
repeating said single measurement gross error test on a plurality of single items of said data;
if gross errors are detected in a number of said single items of said data, determining whether said gross errors can be classified as a group representing a gross model mis-specification, and if so whether the cause of said mis-specification can be identified;
if said cause of said mis-specification can be identified, correcting said gross errors; and
if said cause of said mis-specification cannot be identified, omitting said number of single items of said data from said subsurface model or assigning to said number of single items of said data different prior uncertainties.

16. The method as claimed in claim 1, which includes performing a systematic gross error test to determine whether a group of items of said data are affected by a systematic error.

17. The method as claimed in claim 16, wherein said systematic gross error test is a statistical hypothesis test.

18. The method as claimed in claim 16, wherein said group of items of said data are one of the following: a group of well picks, a group of geological feature points within a volume around said at least one of said one or more wellbores, or a group of measurements performed by one or more sensors in said at least one of said one or more wellbores.

19. The method as claimed in claim 16, further comprising the following steps if a systematic error is detected:
if the cause of said systematic error is detected, correcting said group of items of said data; and
if the cause of said systematic error is not detected, either ignoring said group of items of said data or including said group of items of said data in said subsurface model with a modified prior uncertainty.

20. A method as claimed in claim 16, which further comprises, if a systematic error is detected, calculating the estimated systematic error, and using the estimated systematic error, and an estimated residual noise of measurements taken by said measurement instruments, correcting or calibrating said measurements taken by said measurement instruments in real time to provide a better positioning of subsurface features in said subsurface model.

21. The method as claimed in claim 20, wherein said correcting or calibrating steps are done after drilling in said at least one wellbore.

22. The method as claimed in claim 1, which comprises:
a) selecting a subset of said data;
b) performing an overall consistency test on said data;
c) performing a single measurement gross error test on said subset;
d) performing a systematic gross error test on said subset;
e) from steps c) and d) deriving a single test value;
f) determining whether said single test value is greater than a test limit; and
g) if said single test value is greater than said test limit, omitting said subset of said data from said subsurface model.

23. The method as claimed in claim 1, which further comprises repeating the steps of said method in an iterative manner.

24. A method of performing a survey comprising:
obtaining data comprising a plurality of types of data relating to a subsurface model of a region around a wellbore; and
performing on said data a method of quality control as claimed in claim 1.

25. The method of performing a survey as claimed in claim 24, which includes obtaining said wellbore data from said one or more measurement instruments located within said at least one of said one or more wellbores.

26. A method of extracting hydrocarbons from a subsurface region of the earth, said method comprising:
drilling a wellbore;
performing a survey as claimed in claim 24;
using the results of said survey to locate the presence of hydrocarbons in said subsurface region of the earth; and
extracting said hydrocarbons via said wellbore.

27. A method of drilling a wellbore in a subsurface region of the earth, for the purpose or extraction of geothermal energy, or any other purpose, said method comprising:
commencing drilling of a wellbore;
performing a survey as claimed in claim 24;
using the results of said survey to determine the desired position of the wellbore in said subsurface region of the earth; and
continuing drilling of said wellbore in accordance with said desired position.

28. A non-transitory computer readable medium carrying instructions for performing the method of claim 1.

29. A computer programmed to carry out the method of claim 1.
